(19) United States
(12) Patent Application Publication
(10) Pub. No.: US 2012/0206230 A1
(43) Pub. Date: Aug. 16, 2012

(54) LOW-LOSS CHOKE STRUCTURE WITH NO AIR GAP

(76) Inventors: Chen-En LIAO, Taipei (TW); Zhi-Liang Zhang, Taipei (TW); Yi-Lin Chen, Taipei (TW)

(21) Appl. No.: 13/076,995

(22) Filed: Mar. 31, 2011

(30) Foreign Application Priority Data
Feb. 10, 2011 (TW) 100104432

(51) Int. Cl. H01F 27/29

(52) U.S. Cl. 336/192

(57) ABSTRACT

A low-loss choke structure with no air gap includes a magnetic core unit, a coil and an insulator. The magnetic core unit has two magnetic cores. Each of the magnetic cores has a post. The coil has a wired portion. The wired portion has an input end and an output end. The two posts of the magnetic cores are respectively inserted into opposite sides of the wired portion and each have an end face contacting each other. The input end and the output end both are inserted into the insulator, which is arranged below the magnetic cores. There is no air gap between the two end faces of the two posts, thus lowering the eddy current loss, suppressing the noise generation, decreasing cost and size, and providing improved DC bias characteristics.

### BACKGROUND OF THE INVENTION

1. Field of the Invention

The present invention relates to a choke, in particularly to a choke structure with no air gap.

2. Description of Related Art

FIG. 1 and FIG. 2 show a conventional choke. The choke includes a bobbin 10, two magnetic cores 20 and a coil 30. The coil 30 is wired around the bobbin 10. The two magnetic cores 20 each have a post 201 passing through the holes 101 of the bobbin 10. The two posts 201 both attached on the bobbin 10, thus forming a choke. After the two magnetic cores 20 are attached on the bobbin 10, an air gap 202 is formed between the two posts 201 of the magnetic cores 20. The dimensions of the air gap 202 can be used to adjust the inductance value of the choke.

Since the choke has characteristic of blocking or suppressing AC current from passing through, it has widely been used on electrical power apparatus such as power supply unit or power generator. However, the current choke has some problems as below to be solved.

1. There is an air gap between the two posts of the magnetics. Such an air gap cause significant eddy current loss, which lowers the efficiency of the power supply unit.

2. The air gap between the posts makes some noise while operating due to the magnetic field therein.

3. Conventionally, either adhesive material or tape can be applied in the air gap to eliminate the noise from the air gap. However, such an additional step causes cost increases and manufacturing more complicated.

4. The air gap between the two posts may cause saturation on the magnetic cores and degrade the DC bias performance.

5. The bobbin for wiring the coil takes too much space and makes the dimensions of the choke larger, which is not consistent with the requirement of miniaturization.

6. The wiring process of the coil is manually operated by hand, which increases the manufacturing cost.

7. The design of the coil wired on the bobbin increases the DC impedance and the overall dimensions of the choke, and leads to wasting of material.

### SUMMARY OF THE INVENTION

Therefore, the main objective of the present invention aims to solve the conventional problem and to provide a choke structure having no air gap therein. And such a choke structure also has no bobbin and no cover.

For achieving the abovementioned objective, the present invention provides a low-loss choke structure with no air gap mainly including a magnetic core unit and a coil. The magnetic core unit has a first magnetic core and a second magnetic core. The first magnetic core has a first plate, a first post extending from the first plate and two first side portions extending from two opposite sides of the first plate. A first accommodating space is defined between the first post and the first side portions. The first post has a first end face. The second magnetic core has a second plate, a second post extending from the second plate and two second side portions extending from two opposite sides of the second plate. A second accommodating space is defined between the second post and the second side portions. The second post has a second end face. The coil is wired around the first post and the second post and located in the first accommodating space and the second accommodating space. The first end face of the first post fully contacts with the second end face of the second post and there is substantially no air gap between the first end face and the second end face.

Since there is no air gap between the first and second posts, the eddy current loss from the air gap of the magnetic core unit can be lowered, and the efficiency of the power supply unit can be improved. The noise while operating due to the magnetic field can be eliminated for there is no air gap between the first post and the second post. The magnetic core unit with no air gap has lager capacitance so that the wiring number can be reduced, and thus meeting the requirement of miniaturization. No adhesive material or tape needs to be applied between the first post and the second post. The magnetic core with low permeability and high magnetic flux can improve the DC bias characteristic. Because of no air gap and strip-shaped wire, the DC resistance of the choke of the present invention is lower than conventional means. And there is no bobbin or cover needed.

### BRIEF DESCRIPTION OF THE DRAWINGS

FIG. 1 shows a schematic view of the conventional choke structure;

FIG. 2 shows a sectional view of the choke structure in FIG. 1;

FIG. 3 shows a perspective view of the choke structure of the present invention;

FIG. 4 shows an exploded view of the choke structure of the present invention;

FIG. 5 shows a sectional view of the choke structure of the present invention;

FIG. 6 shows a schematic view of another magnetic core unit of the present invention;

FIG. 7 shows a schematic view of another magnetic core unit of the present invention; and

FIG. 8 shows a schematic view of another magnetic core unit of the present invention.

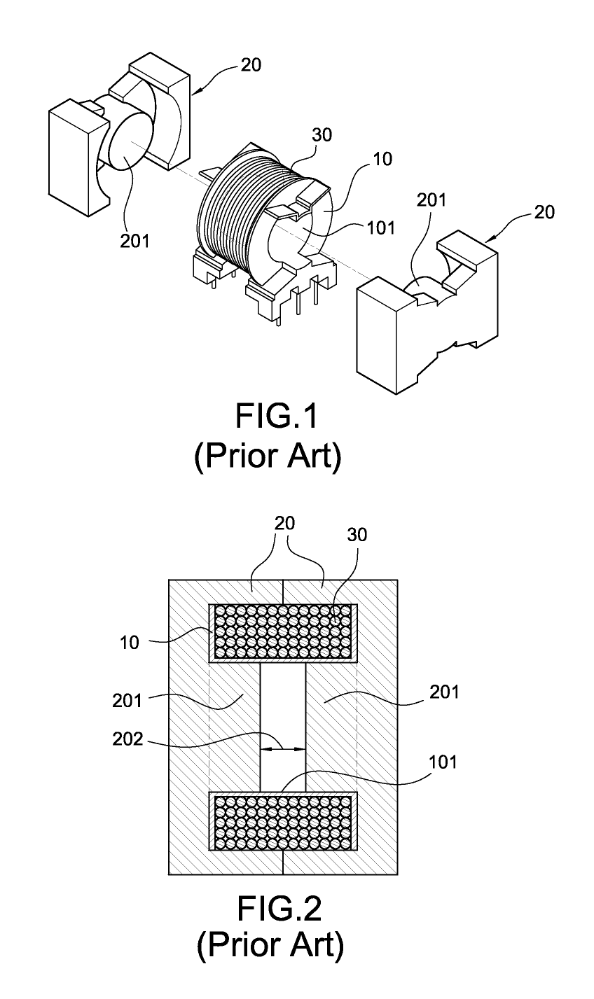

### DETAILED DESCRIPTION OF THE INVENTION

A detailed description of the present invention will be made with reference to the accompanying drawings.

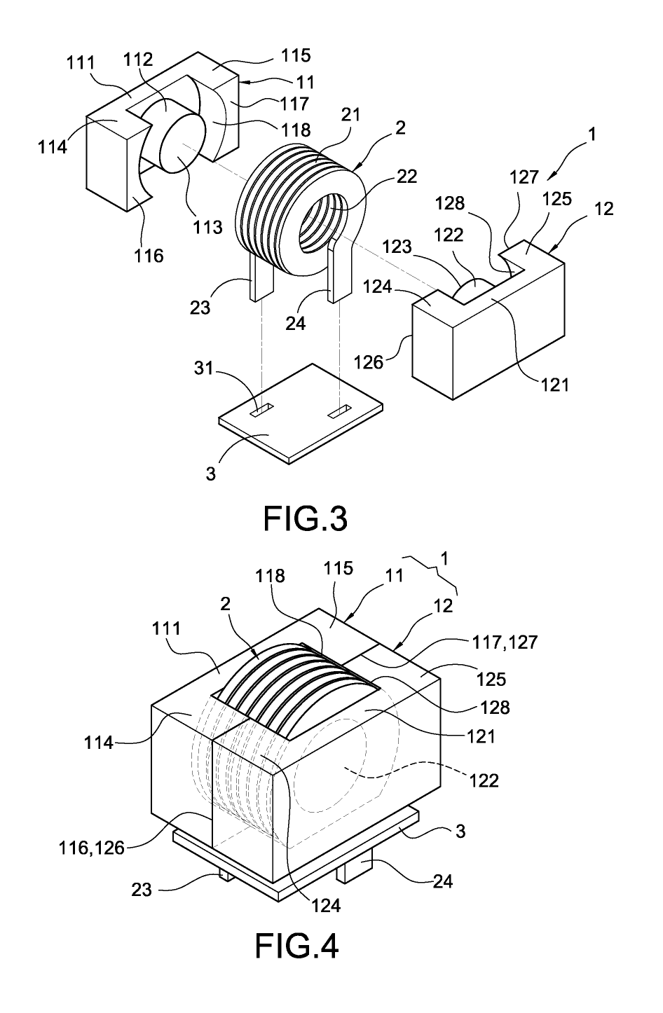

As FIG. 3 and FIG. 4 show, the low-loss choke structure with no air gap mainly includes a magnetic core unit 1, a coil 2 and a insulator 3.

The magnetic core unit 1 has a first magnetic core 11 and a second magnetic core 12. The shape of the first magnetic core 11 is consistent with the shape of the second magnetic core 12. The first magnetic core 11 has a first plate 111, a first post 112 extending from the first plate 111 and two first side portions 114`115 extending from two opposite sides of the first plate 111. The first post 112 is cylinder-shaped, rectangular cuboid-shaped or polyhedron-shaped. The first post 112 has a first end face 113. Each of the first side portions 114, 115 has a first terminal face 116, 117. The length of the first post 112 equals to the length of the first side portions 114, 115. A first accommodating space 118 is defined between the first post 112 and the first side portions 114`115.

The second magnetic core 12 has a second plate 121, a second post 122 extending from the second plate 121 and two second side portions 124`125 extending from two opposite sides of the second plate 121. The second post 122 is cylinder-shaped, rectangular cuboid-shaped or polyhedron-shaped. The second post 122 has a second end face 123. Each of the second side portions 124, 125 has a second terminal face 126, 127. The length of the second post 122 equals to the length of the second side portions 124, 125. A second accommodating space 128 is defined between the second post 122 and the second side portions 124`125.

The coil 2 is a strip-shaped copper wire. The coil 2 has a wired portion 21 which has a through hole 22 for arranging around the first post 112 and the second post 122. The wired portion 21 has an input end 23 and an output end 24.

The insulator 3 is made of plastic material and is planar-shaped. It is arranged below the magnetic core unit 1. The insulator 3 has two via holes 31 for passing through the input end 23 and output end 24. When the choke of this invention is to connect to a circuit board (not shown), the insulator 3 can electrically isolate the magnetic core unit 1 and the coil 2 from the circuit board.

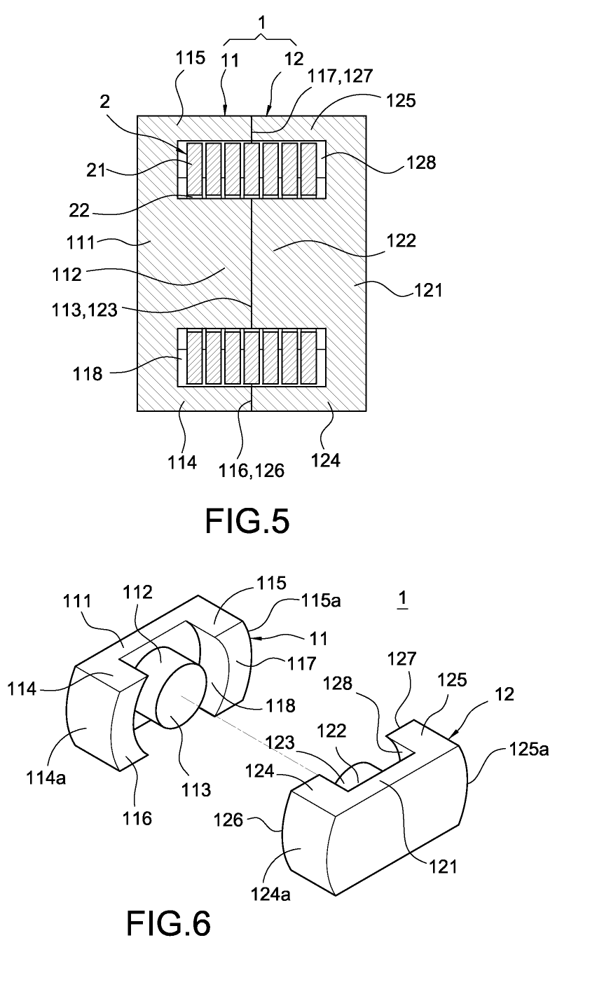

As FIG. 5 shows, when assembling the magnetic core unit 1, the coil 2 and the isolator 3, the first post 112 of the first magnetic core 11 and the second post 122 of the second magnetic core 12 are arranged into the through hole 22 of the wired portion 21 of the coil 2. And the wired portion 21 is located in the first accommodating space 118 of the first magnetic core 11 and the second accommodating space 128 of the second magnetic core 12. The input end 23 and the output end 24 of the coil 2 extend from a same side of the first plate 111 and the second side 121. Adhesive material is applied on the first terminal face 116, 117 of the first side portions 114, 115 and the second terminal face 126, 127 of the second side portions 124, 125, thus connecting the first magnetic core 11 with the second magnetic core 12. The input end 23 and the output end 24 of the coil 2 are then inserted into the two via hole 31 of the insulator 3. The insulator 3 is then located below the first magnetic core 11 and the second magnetic core 12.

After the assembly is finished, the first end face 113 of the first post 112 fully contacts with the second end face 123 of the second post 122. And there is no air gap between the first post 112 and the second post 122. Such a design has advantages below:

1. The eddy current loss from the air gap of the magnetic core unit can be lowered, and the efficiency of the power supply unit can be improved.

2. The noise while operating due to the magnetic field can be eliminated for there exists no air gap between the first post and the second post.

3. Comparing to conventional choke, the magnetic core unit with no air gap has lager capacitance so that the wiring number can be reduced, and thus meeting the requirement of miniaturization.

4. No adhesive material or tape needs to be applied between the first post and the second post.

5. The magnetic core with low permeability and high magnetic flux can improve the DC bias characteristic.

6. Because of no air gap and strip-shaped wire, the DC resistance of the choke of the present invention is lower than conventional means. And there is no bobbin or cover needed.

As FIG. 6 shows, each of the first side portions 114, 115 has an outer face 114a, 115a, and each of the second side portions 124, 125 has an outer face 124a, 125a. The outer faces 114a, 115a, 124a and 125a are arc-shaped.

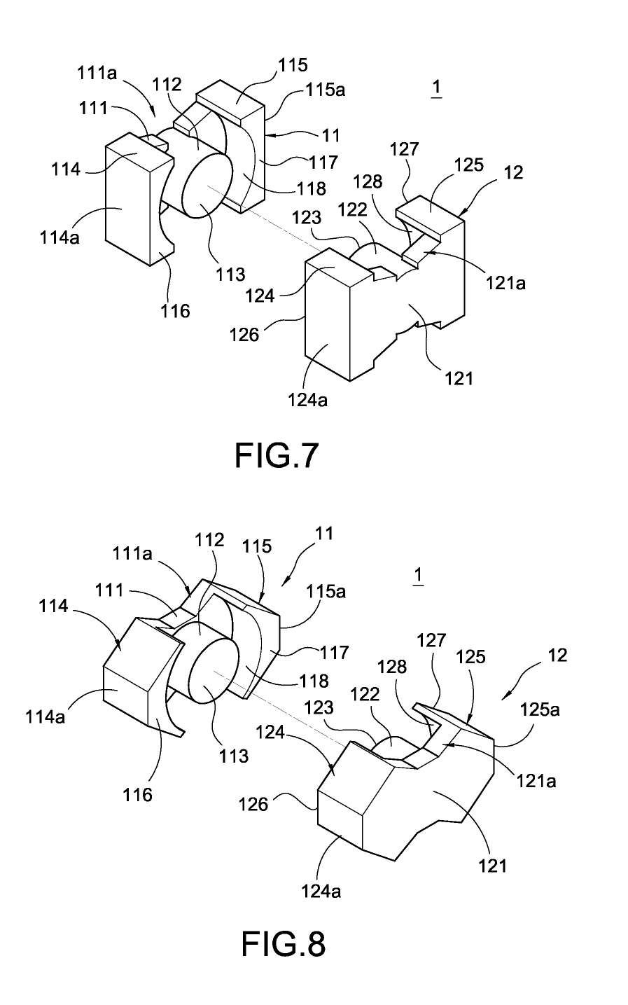

As FIG. 7 shows, each of the first side portions 114, 115 and the second side portions 124, 125 has a planar outer face 114a, 115a, 124a and 125a. The two sides of the first plate 111 have recess portions 111a allowing the first post 112 has larger first end face 113. The two sides of the second plate 121 have recess portions 121a allowing the second post 12 has larger second end face 123. Such a choke structure can have a better capacitance.

As FIG. 8 shows, each of the first side portions 114, 115 and the second side portions 124, 125 has a polyhedron outer face 114a, 115a, 124a and 125a. The two sides of the first plate 111 have recess portions 111a allowing the first post 112 has larger first end face 113. The two sides of the second plate 121 have recess portions 121a allowing the second post 12 has larger second end face 123. Such a choke structure can have a better capacitance.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A low-loss choke structure with no air gap, comprising:
a magnetic core unit having a first magnetic core and a second magnetic core, the first magnetic core having a first plate, a first post extending from the first plate and two first side portions extending from two opposite sides of the first plate, an first accommodating space being defined between the first post and the first side portions, the first post having a first end face, the second magnetic core having a second plate, a second post extending from the second plate and two second side portions extending from two opposite sides of the second plate, an second accommodating space being defined between the second post and the second side portions, the second post having a second end face; and
a coil wired around the first post and the second post and located in the first accommodating space and the second accommodating space,
wherein the first end face of the first post fully contacts with the second end face of the second post and there is substantially no air gap between the first end face and the second end face.

2. The low-loss choke structure with no air gap as claim 1, wherein the first side portion has a first terminal face and the second side portion has a second terminal face.

3. The low-loss choke structure with no air gap as claim 2, further comprising adhesive material applied on the first terminal face and the second terminal face.

4. The low-loss choke structure with no air gap as claim 3, wherein the length of the first post equals to the length of the first side portions, the length of the second post equals to the length of the second side portions.

5. The low-loss choke structure with no air gap as claim 4, wherein the first post and the second post are cylinder-shaped, rectangular cuboid-shaped or polyhedron-shaped.

6. The low-loss choke structure with no air gap as claim 5, wherein each of the first side portions and the second side portions has an outer face and an inner face, the outer face and the inner face are arc-shaped.

7. The low-loss choke structure with no air gap as claim 5, wherein each of the first side portions and the second side portions has a planar outer face.

8. The low-loss choke structure with no air gap as claim 7, wherein a side of the first plate has a recess portion allowing the first post has lager first end face, a side of the second plate has a recess portion allowing the second post has lager second end face.

9. The low-loss choke structure with no air gap as claim 5, wherein each of the first side portions and the second side portions has a polyhedron outer face.

10. The low-loss choke structure with no air gap as claim 9, wherein the two sides of the first plate have recess portions allowing the first post has lager first end face, two sides of the second plate have recess portions allowing the second post has lager second end face.

11. The low-loss choke structure with no air gap as claim 1, wherein the coil has a wired portion which has a through hole for arranging around the first post and the second post, the wired portion has an input end and an output end.

12. The low-loss choke structure with no air gap as claim 11, wherein the coil is a strip-shaped copper wire.

13. The low-loss choke structure with no air gap as claim 12, further comprising a planar insulator arranged below the magnetic core unit, the planar insulator has two via holes for passing through the input end and output end.

14. The low-loss choke structure with no air gap as claim 13, wherein the insulator is made of plastic material.
